(19) United States
(12) Patent Application Publication
(10) Pub. No.: US 2025/0386280 A1
(43) Pub. Date: Dec. 18, 2025

(54) ACCESS POINT, DATA RECEIVING METHOD AND DATA RECEIVING PROGRAM

(71) Applicant: Nippon Telegraph and Telephone Corporation, Tokyo (JP)

(72) Inventors: Akira Kishida, Musashino-shi, Tokyo (JP); Yusuke Asai, Musashino-shi, Tokyo (JP); Yasushi Takatori, Musashino-shi, Tokyo (JP); Junichi Iwatani, Musashino-shi, Tokyo (JP); Hirantha Abeysekera, Musashino-shi, Tokyo (JP); Riku Omiya, Musashino-shi, Tokyo (JP); Shinya Otsuki, Musashino-shi, Tokyo (JP); Hanae Otani, Musashino-shi, Tokyo (JP)

(21) Appl. No.: 18/878,757

(22) PCT Filed: Jul. 5, 2022
(86) PCT No.: PCT/JP2022/026722

§ 371 Date: Dec. 24, 2024

(51) Int. Cl. H04W 48/08; H04W 76/10

(52) U.S. Cl. CPC H04W 48/08; H04W 76/10

(57) ABSTRACT

An access point of an embodiment includes a wireless signal processing unit and a management unit. The management unit sets a first service period for providing a first traffic transmission opportunity to the first wireless terminal apparatus in a first cycle and a second service period for providing a second traffic transmission opportunity to the second wireless terminal apparatus in a second cycle. The management unit manages a first transmission priority based on a delay requirement condition of the first traffic and a second transmission priority based on a delay requirement condition of the second traffic. In a case of detecting a conflict between the first and second service periods is detected and confirming that the first transmission priority is higher than the second transmission priority, the management unit notifies the second wireless terminal apparatus of a change in a configuration related to the second service period.

### TECHNICAL FIELD

Embodiments relate to an access point, a data receiving method, and a data receiving program.

### BACKGROUND ART

A wireless local area network (LAN) is known as a communication system that wirelessly connects an access point to a wireless terminal apparatus. The wireless terminal apparatus can access the network via the access point in a communication area by using the wireless LAN. In addition, the access point and the wireless terminal apparatus may be provided with a service period for preferentially exchanging traffic for which low latency is requested (low latency traffic).

### CITATION LIST

### Non Patent Literature

Non Patent Literature 1: IEEE P802. 11beTM/D1.5, “35.9 Restricted TWT (r-TWT)”, Mar. 18, 2022

### SUMMARY OF INVENTION

### Technical Problem

An object is to control a plurality of wireless terminal apparatuses so as to satisfy a delay requirement condition of low latency traffic of each of the plurality of wireless terminal apparatuses.

### Solution to Problem

An access point of an embodiment includes a wireless signal processing unit and a management unit. The management unit is configured to establish, by using the wireless signal processing unit, a first link with a first wireless terminal apparatus and a second link with a second wireless terminal apparatus. The management unit sets a first service period for providing a first traffic transmission opportunity to the first wireless terminal apparatus in a first cycle and a second service period for providing a second traffic transmission opportunity to the second wireless terminal apparatus in a second cycle. The management unit manages a first transmission priority based on a delay requirement condition of the first traffic and a second transmission priority based on a delay requirement condition of the second traffic. In a case of detecting a conflict between the first service period and the second service period is detected and confirming that the first transmission priority is higher than the second transmission priority, the management unit notifies the second wireless terminal apparatus of a change in a configuration related to the second service period.

### Advantageous Effects of Invention

The device of the embodiment can control the plurality of wireless terminal apparatuses to satisfy the delay requirement condition of the low latency traffic of each of the plurality of wireless terminal apparatuses.

### BRIEF DESCRIPTION OF DRAWINGS

FIG. 1 is a block diagram illustrating an example of a configuration of a communication system according to a first embodiment.

FIG. 2 is a time chart illustrating an outline of an rTWT function of the communication system according to the first embodiment.

FIG. 3 is a block diagram illustrating an example of a hardware configuration of an access point included in the communication system according to the first embodiment.

FIG. 4 is a block diagram illustrating an example of a hardware configuration of a wireless terminal apparatus included in the communication system according to the first embodiment.

FIG. 5 is a block diagram illustrating an example of a functional configuration of the access point included in the communication system according to the first embodiment.

FIG. 6 is a block diagram illustrating an example of a functional configuration of the wireless terminal apparatus included in the wireless communication system according to the first embodiment.

FIG. 7 is a block diagram illustrating an example of a configuration of a channel access function of the access point included in the communication system according to the first embodiment.

FIG. 8 is a flowchart illustrating an example of a link setup method of the communication system according to the first embodiment.

FIG. 9 is a schematic diagram illustrating an example of a format of a beacon frame transmitted by the access point included in the communication system according to the first embodiment.

FIG. 10 is a table illustrating an example of link management information of the access point included in the communication system according to the first embodiment.

FIG. 11 is a flowchart illustrating an example of a method of setting an rTWT service period in the communication system according to the first embodiment.

FIG. 12 is a time chart illustrating a specific example of a frame exchange method using the rTWT function of the communication system according to the first embodiment.

FIG. 13 is a flowchart illustrating an example of a method of setting an rTWT service period in a communication system according to a second embodiment.

FIG. 14 is a time chart illustrating a specific example of a frame exchange method using an rTWT function of the communication system according to the second embodiment.

FIG. 15 is a block diagram illustrating an example of a configuration of a communication system according to a third embodiment.

FIG. 16 is a flowchart illustrating an example of a communication control method in the communication system according to the third embodiment.

### DESCRIPTION OF EMBODIMENTS

Hereinafter, each embodiment will be described with reference to the drawings. Each embodiment exemplifies a device and a method of embodying the technical idea of the invention.

The drawings are schematic or conceptual. In the following description, components having the same function and configuration are denoted by common reference numerals.

### <1> First Embodiment

An access point included in a communication system 1 according to a first embodiment allocates a service period in which traffic for which low latency is requested can be preferentially exchanged to a wireless terminal apparatus. Then, in a case where the respective service periods of a plurality of the wireless terminal apparatuses conflict with each other, the access point causes each wireless terminal apparatus to transmit the traffic in an order according to a transmission priority. Hereinafter, details of the communication system 1 according to the first embodiment will be described.

### <1-1> Configuration

### <1-1-1> Overall Configuration of Communication System 1

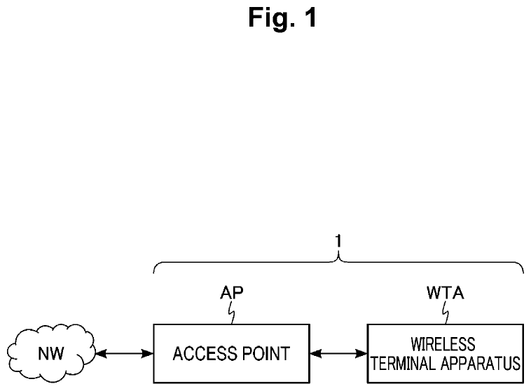

FIG. 1 is a block diagram illustrating an example of a configuration of the communication system 1 according to the first embodiment. As illustrated in FIG. 1, the communication system 1 includes an access point AP and a wireless terminal apparatus WTA.

The access point AP is a base station of a wireless LAN or the like. The access point AP is configured to be able to wirelessly communicate with the wireless terminal apparatus WTA. Further, the access point AP is configured to be able to communicate with a server (not illustrated) on a network NW.

The wireless terminal apparatus WTA is a wireless terminal such as a smartphone or a personal computer (PC). The wireless terminal apparatus WTA is configured to be able to communicate with a server on the network NW via the access point AP.

Communication between the access point AP and the wireless terminal apparatus WTA conforms to, for example, the IEEE 802.11 standard. The IEEE 802.11 standard has, for example, a wireless communication function based on an open systems interconnection (OSI) reference model. In the OSI reference model, the wireless communication function is divided into seven layers (the first layer: a physical layer, the second layer: a data link layer, the third layer: a network layer, the fourth layer: a transport layer, the fifth layer: a session layer, the sixth layer: a presentation layer, and the seventh layer: an application layer). The data link layer includes a logical link control (LLC) sublayer and a media access control (MAC) sublayer.

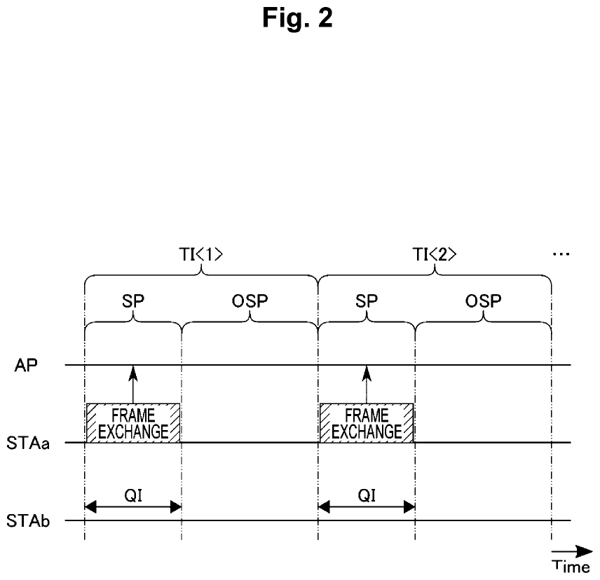

In the communication system 1, each of the access point AP and the wireless terminal apparatus WTA supports a restricted-target wake time (rTWT) function. The rTWT function is a function to allocate a service period in which low latency traffic can be preferentially exchanged to a predetermined wireless terminal apparatus WTA. The low latency traffic is traffic (data) having a delay time condition (delay requirement condition) requested by an application. Hereinafter, an outline of the rTWT function will be described with reference to FIG. 2.

FIG. 2 is a time chart illustrating an outline of the rTWT function of the communication system 1 according to the first embodiment. As illustrated in FIG. 2, the access point AP sets an rTWT service period SP at a constant cycle. The rTWT service period SP corresponds to a service period used for transmission of low latency traffic. Hereinafter, the cycle in which the rTWT service period SP is set is referred to as “rTWT cycle”. An interval between adjacent rTWT service periods SP is referred to as an “rTWT interval TI”. The rTWT interval TI corresponds to one cycle of the rTWT cycle. FIG. 2 illustrates consecutive rTWT intervals TI <1> and TI <2> in the rTWT cycle.

Each TWT interval TI includes the rTWT service period SP and a period OSP. The period OSP corresponds to a period that does not overlap with the rTWT service period SP, that is, outside the period of the rTWT service period SP. The rTWT service period SP is determined by rTWT start time TS and an rTWT duration TD. The rTWT start time TS corresponds to start time of the rTWT service period SP. The rTWT duration TD corresponds to a length of the rTWT service period SP starting from the rTWT start time TS.

In the rTWT service period SP, the access point AP preferentially gives a frame exchange opportunity to the wireless terminal apparatus WTA (STAa in FIG. 2) supporting the rTWT function. The frame exchange opportunity corresponds to an opportunity in which the traffic (data) is transmitted by frame exchange between the access point AP and the wireless terminal apparatus WTA. Meanwhile, the access point AP sets a transmission suppression period QI for the wireless terminal apparatus WTA (STAb in FIG. 2) that does not support the rTWT function. The transmission suppression period QI corresponds to a period in which transmission of the traffic between the access point AP and the wireless terminal apparatus WTA is suppressed. The transmission suppression period QI overlaps with the rTWT service period SP. Further, the transmission suppression period QI is set to the same length as or shorter than the rTWT service period SP.

The wireless terminal apparatus WTA can recognize time based on the rTWT start time TS and the rTWT cycle (or the rTWT interval TI) as the rTWT start time TS of the next rTWT service period SP. The wireless terminal apparatus WTA transmits the low latency traffic to the access point AP on the basis of, for example, reception of a trigger frame from the access point AP in the rTWT service period SP. The trigger frame is a frame used in a case where the access point AP requests the wireless terminal apparatus WTA to transmit traffic. The access point AP may transmit the trigger frame to the wireless terminal apparatus WTA at the rTWT start time TS. In the rTWT service period SP, the wireless terminal apparatus WTA can preferentially transmit the low latency traffic, and can improve latency of the low latency traffic.

Note that the access point AP may set parameters (hereinafter also referred to as an “rTWT configuration”) of the rTWT function such as the rTWT start time TS and the rTWT duration TD for each link or may manage the parameters for each group of links. The frame exchange in the rTWT service period SP may be executed by carrier sense multiple access with collision avoidance (CSMA/CA). The access point AP preferably sets the rTWT cycle in accordance with the transmission cycle of the low latency traffic. For example, the access point AP may set the parameters of the rTWT function on the basis of an attribute of the traffic. In this case, the access point AP notifies a server on the network NW of a type of the traffic to acquire a corresponding attribute of the traffic. Then, the access point AP determines the parameters of the rTWT function on the basis of the acquired attribute of the traffic. Examples of the attribute of traffic include an occurrence interval and a data amount of the traffic notification of which is provided from the application that generates the low latency traffic.

### <1-1-2> Hardware Configuration of Communication System 1

### (Hardware Configuration of Access Point AP)

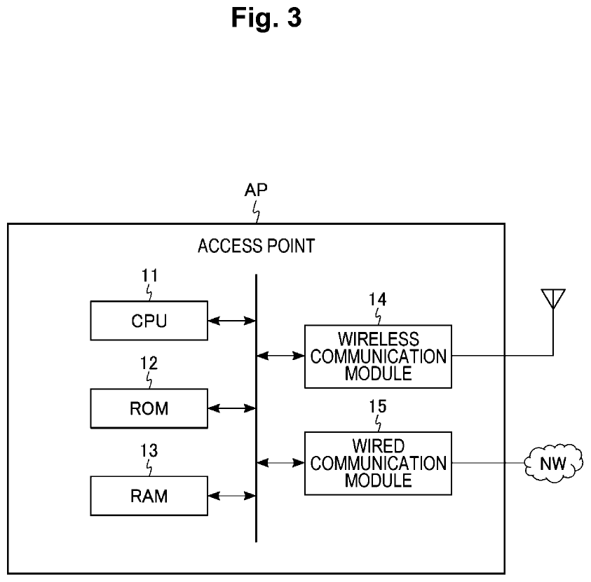

FIG. 3 is a block diagram illustrating an example of a hardware configuration of the access point AP included in the communication system 1 according to the first embodiment. As illustrated in FIG. 3, the access point AP includes, for example, a central processing unit (CPU) 11, a read only memory (ROM) 12, a random access memory (RAM) 13, a wireless communication module 14, and a wired communication module 15.

The CPU 11 is an integrated circuit capable of executing various programs and controls an operation of the entire access point AP. The ROM 12 is a nonvolatile semiconductor memory and stores a program for controlling the access point AP, control data, and the like. The RAM 13 is, for example, a volatile semiconductor memory, and is used as a working area for the CPU 11. The wireless communication module 14 is a circuit used to transmit and receive data with a wireless signal and is configured to be connectable to an antenna. The wired communication module 15 is a circuit used to transmit and receive data with a wired signal and is configured to be connectable to the network NW. Note that the access point AP may have another hardware configuration. For example, in the case where the access point AP is wirelessly connected to the network NW, the wired communication module 15 may be omitted from the access point AP.

### (Hardware Configuration of Wireless Terminal Apparatus WTA)

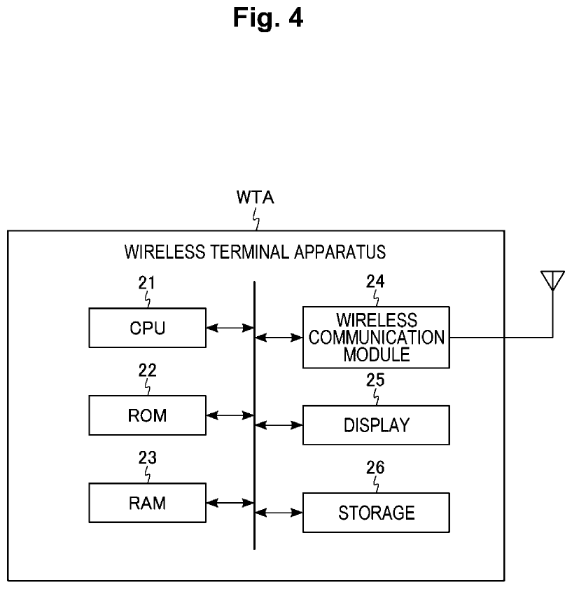

FIG. 4 is a block diagram illustrating one example of a hardware configuration of the wireless terminal apparatus WTA included in the communication system 1 according to the first embodiment. As illustrated in FIG. 4, the wireless terminal apparatus WTA includes, for example, a CPU 21, a ROM 22, a RAM 23, a wireless communication module 24, a display 25, and a storage 26.

The CPU 21 is an integrated circuit capable of executing various programs and controls an operation of the entire wireless terminal apparatus WTA. The ROM 22 is a nonvolatile semiconductor memory and stores a program for controlling the wireless terminal apparatus WTA, control data, and the like. The RAM 23 is, for example, a volatile semiconductor memory, and is used as a working area for the CPU 21. The wireless communication module 24 is a circuit used to transmit and receive data by a wireless signal and is configured to be connectable to an antenna. The display 25 displays, for example, a graphical user interface (GUI) corresponding to application software. The display 25 may have a function as an input interface of the wireless terminal apparatus WTA. The storage 26 is a nonvolatile storage device, and stores, for example, system software or the like of the wireless terminal apparatus WTA. Note that the wireless terminal apparatus WTA may have another hardware configuration. For example, when the wireless terminal apparatus WTA is an Internet of Things (IOT) terminal or the like, the display 25 may be omitted from the wireless terminal apparatus WTA.

### <1-1-3>Functional Configuration of Communication System 1

### (Functional Configuration of Access Point AP)

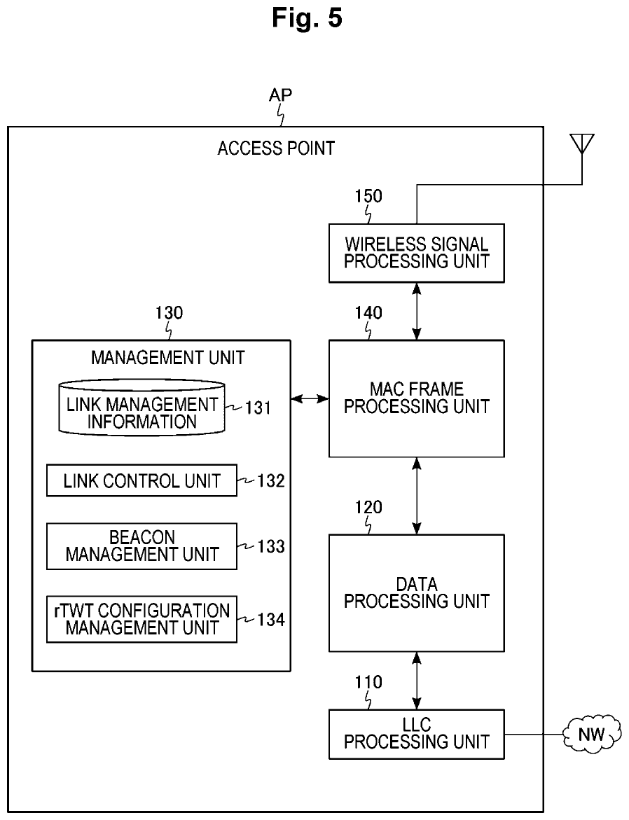

FIG. 5 is a block diagram illustrating an example of a functional configuration of the access point AP included in the communication system 1 according to the first embodiment. As illustrated in FIG. 5, the access point AP functions as a computer including, for example, an LLC processing unit 110, a data processing unit 120, a management unit 130, a MAC frame processing unit 140, and a wireless signal processing unit 150. The LLC processing unit 110 is a functional block that executes processing corresponding to the LLC sublayer of the second layer and the third layer to the seventh layer. The data processing unit 120, the management unit 130, and the MAC frame processing unit 140 are functional blocks that execute processing corresponding to the MAC sublayer of the second layer. The wireless signal processing unit 150 is a functional block that executes processing corresponding to the MAC sublayer of the second layer and the first layer.

The LLC processing unit 110 adds, for example, a destination service access point (DSAP) header, a source service access point (SSAP) header, and the like to the data received from the network NW to generate an LLC packet. Then, the LLC processing unit 110 inputs the generated LLC packet to the data processing unit 120. In addition, the LLC processing unit 110 extracts data from the LLC packet input from the data processing unit 120. Then, the LLC processing unit 110 transmits the extracted data to the network NW.

The data processing unit 120 adds a MAC header to the LLC packet input from the LLC processing unit 110 to generate a MAC frame. Then, the data processing unit 120 inputs the generated MAC frame to the MAC frame processing unit 140. In addition, the data processing unit 120 extracts the LLC packet from the MAC frame input from the MAC frame processing unit 140. Then, the data processing unit 120 inputs the extracted LLC packet to the LLC processing unit 110. The MAC frame including data is also referred to as a “data frame”.

The management unit 130 manages a state of a link between the access point AP and the wireless terminal apparatus WTA. The MAC frame including management information related to the link, the rTWT function, and the like is input and output between the management unit 130 and the MAC frame processing unit 140. The MAC frame including the management information is also referred to as a “management frame”. The management unit 130 includes, for example, link management information 131, a link control unit 132, a beacon management unit 133, and an rTWT configuration management unit 134.

The link management information 131 includes information regarding the link between the access point AP and the wireless terminal apparatus WTA wirelessly connected. Furthermore, the link management information 131 may include information regarding the configuration of the rTWT function such as the rTWT start time TS, the rTWT duration TD, and a transmission priority. The transmission priority indicates the priority of the traffic to be transmitted in a case where a plurality of wireless terminal apparatuses WTA use the rTWT function and the rTWT service periods SP conflict with each other. The transmission priority is determined on the basis of, for example, the delay requirement condition of the low latency traffic, the priority of the traffic (stream classification service (SCS)), and a traffic identifier (TID). The access point AP manages the plurality of wirelessly connected wireless terminal apparatuses WTA using the link management information 131.

The link control unit 132 controls establishment of the link between the access point AP and the wireless terminal apparatus WTA. For example, the link control unit 132 executes association processing and subsequent authentication processing in response to a connection request from the wireless terminal apparatus WTA. The link control unit 132 can control a state of the link established with the wireless terminal apparatus WTA.

The beacon management unit 133 manages information to be transmitted as a beacon by the access point AP. Furthermore, the beacon management unit 133 periodically generates a management frame including management information, and inputs the generated management frame to the MAC frame processing unit 140. The management frame generated by the beacon management unit 133 is also referred to as a “beacon frame”. The management information transmitted as a beacon by the beacon management unit 133 includes, for example, the information regarding the configuration of the rTWT function. In other words, the beacon management unit 133 can notify the wireless terminal apparatus WTA of the rTWT start time TS and the rTWT duration TD with the beacon.

The rTWT configuration management unit 134 manages the rTWT configuration for each set up single or plurality of wireless terminal apparatuses WTA and the transmission priority of the low latency traffic. The transmission priority is, for example, a parameter uniquely determined by the rTWT configuration management unit 134 on the basis of the SCS, traffic identifier (TID), and the like. The rTWT configuration management unit 134 may refer to the delay requirement condition or a condition such as jitter of the traffic notification of which is provided from an upper layer in determining the transmission priority. For example, the rTWT configuration management unit 134 determines a higher transmission priority as the delay requirement condition is stricter, and determines a higher transmission priority as the jitter is larger. Further, the rTWT configuration management unit 134 may determine the transmission priority of the STA function to be managed on the basis of a notification of another access point AP, a notification of the STA function, or a management number determined in advance. Furthermore, in a case where the plurality of wireless terminal apparatuses WTA uses the rTWT function, the rTWT configuration management unit 134 can confirm whether the transmission of the low latency traffic in the rTWT service period SP conflicts among the plurality of wireless terminal apparatuses WTA. Then, the rTWT configuration management unit 134 can change the configuration of the rTWT function of each wireless terminal apparatus WTA on the basis of a confirmation result and the transmission priority of the low latency traffic of each wireless terminal apparatus WTA. Details of the present operation will be described below.

The MAC frame processing unit 140 inputs the MAC frame input from the data processing unit 120 or the management unit 130 to the wireless signal processing unit 150 corresponding to the link associated with the MAC frame. Further, the MAC frame processing unit 140 inputs the MAC frame input from the wireless signal processing unit 150 to the data processing unit 120 or the management unit 130 according to the type of the MAC frame. Specifically, in a case where the MAC frame is a data frame, the MAC frame processing unit 140 inputs the MAC frame to the data processing unit 120. Further, in a case where the MAC frame is a management frame, the MAC frame processing unit 140 inputs the MAC frame to the management unit 130.

The wireless signal processing unit 150 transmits and receives wireless signals via an antenna. Specifically, in the case of transmitting a wireless signal, the wireless signal processing unit 150 executes carrier sensing for confirming a channel state. In a case where the channel is in a busy state, the wireless signal processing unit 150 continues carrier sensing. In a case where the channel is in an idle state, the wireless signal processing unit 150 generates a wireless frame by adding a preamble or the like to the MAC frame input from the MAC frame processing unit 140. Then, the wireless signal processing unit 150 converts the generated wireless frame into a wireless signal (wireless medium). Then, the wireless signal processing unit 150 radiates (transmits) the converted wireless signal via the antenna. On the other hand, in the case of receiving a wireless signal, the wireless signal processing unit 150 converts the wireless signal received via the antenna into a wireless frame. Then, the wireless signal processing unit 150 extracts the MAC frame from the converted wireless frame, and inputs the extracted MAC frame to the MAC frame processing unit 140.

Note that the wireless signal processing unit 150 may be referred to as an “STA function”. The conversion processing from the wireless frame to the wireless signal by the wireless signal processing unit 150 includes, for example, any of convolutional encoding processing, interleave processing, subcarrier modulation processing, inverse fast Fourier transform processing, orthogonal frequency division multiplexing (OFDM) modulation processing, and frequency conversion processing. The conversion processing from the wireless signal to the wireless frame by the wireless signal processing unit 150 includes, for example, any of frequency conversion processing, OFDM demodulation processing, fast Fourier transform processing, subcarrier demodulation processing, deinterleave processing, and Viterbi decoding processing. The access point AP may include a plurality of the wireless signal processing units 150 that each handles a different channel, or may include a plurality of the wireless signal processing units 150 that handles different frequency bands.

### (Functional Configuration of Wireless Terminal Apparatus WTA)

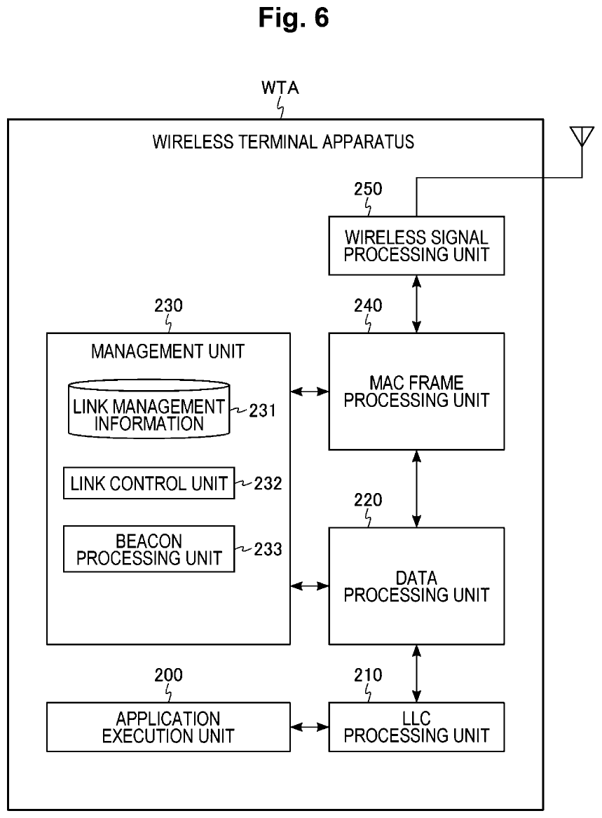

FIG. 6 is a block diagram illustrating an example of a functional configuration of the wireless terminal apparatus WTA included in the communication system 1 according to the first embodiment. As illustrated in FIG. 6, the wireless terminal apparatus WTA functions as a computer including, for example, an application execution unit 200, an LLC processing unit 210, a data processing unit 220, a management unit 230, a MAC frame processing unit 240, and a wireless signal processing unit 250. The application execution unit 200 is a functional block that executes processing corresponding to the seventh layer. The LLC processing unit 210 is a functional block that executes processing corresponding to the LLC sublayer of the second layer and the third layer to the sixth layer. The data processing unit 220, the management unit 230, and the MAC frame processing unit 240 are functional blocks that execute processing corresponding to the MAC sublayer of the second layer. The wireless signal processing unit 250 is a functional block that executes processing corresponding to the MAC sublayer of the second layer and the first layer.

The application execution unit 200 executes an application on the basis of data input from the LLC processing unit 210. In addition, the application execution unit 200 inputs data to the LLC processing unit 210. For example, the application execution unit 200 can display application information on the display 25. Further, the application execution unit 200 can operate on the basis of operation of the input interface.

The LLC processing unit 210 adds a DSAP header, an SSAP header, and the like to data received from the application execution unit 200 to generate the LLC packet. Then, the LLC processing unit 210 inputs the generated LLC packet to the data processing unit 220. In addition, the LLC processing unit 210 extracts data from the LLC packet input from the data processing unit 120. Then, the LLC processing unit 210 inputs the extracted data to the application execution unit 200.

The data processing unit 220 adds the MAC header to the LLC packet input from the LLC processing unit 210 to generate the MAC frame. Then, the data processing unit 220 inputs the generated MAC frame to the MAC frame processing unit 240. In addition, the data processing unit 220 extracts the LLC packet from the MAC frame input from the MAC frame processing unit 240. Then, the data processing unit 220 inputs the extracted LLC packet to the LLC processing unit 210.

The management unit 230 manages the state of the link between the access point AP and the wireless terminal apparatus WTA. The MAC frame including the management information related to the link, the rTWT function, and the like is input and output between the management unit 230 and the MAC frame processing unit 240. The management unit 230 includes, for example, link management information 231, a link control unit 232, and a beacon processing unit 233.

The link management information 231 includes the information regarding the link between the wireless terminal apparatus WTA and the access point AP wirelessly connected. The link management information 231 can also include the information regarding the configuration of the rTWT function, such as the rTWT start time TS and the rTWT duration TD. The wireless terminal apparatus WTA can recognize the rTWT service period SP allocated thereto on the basis of the link management information 231.

The link control unit 232 controls establishment of the link between the access point AP and the wireless terminal apparatus WTA. For example, when transmitting the connection request to the access point AP, the link control unit 232 performs the association processing and the subsequent authentication processing. The link control unit 232 can control the state of the link established with the access point AP.

The beacon processing unit 233 processes the information included in the beacon received from the access point AP. Specifically, the beacon processing unit 233 extracts the management information regarding the rTWT function from the beacon frame input from the MAC frame processing unit 240. Then, the beacon processing unit 233 records, for example, the rTWT start time TS and the rTWT duration TD of the extracted management information regarding the rTWT function in the link management information 231 in association with the link to which the rTWT function is applied. In other words, the beacon processing unit 233 extracts information of a period during which the low latency traffic is transmitted (rTWT service period SP) from the received beacon and reflects the extracted information in the link management information 231. The beacon processing unit 233 may notify the data processing unit 220 of the management information regarding the rTWT function.

The MAC frame processing unit 240 inputs the MAC frame input from the data processing unit 220 or the management unit 230 to the wireless signal processing unit 250 corresponding to the link associated with the MAC frame. Further, the MAC frame processing unit 240 inputs the MAC frame input from the wireless signal processing unit 250 to the data processing unit 220, the management unit 230, or the wireless signal processing unit 250 according to the type of the MAC frame. Specifically, in the case where the MAC frame is a data frame, the MAC frame processing unit 240 inputs the MAC frame to the data processing unit 220. Further, in the case where the MAC frame is a management frame, the MAC frame processing unit 240 inputs the MAC frame to the management unit 230. For example, in the case where the MAC frame is a beacon frame, the MAC frame processing unit 240 inputs the beacon frame to the beacon processing unit 233. In the case where the MAC frame is a trigger frame, the MAC frame processing unit 240 outputs corresponding data to the wireless signal processing unit 250.

The wireless signal processing unit 250 transmits and receives the wireless signals via an antenna. Specifically, in the case of transmitting the wireless signal, the wireless signal processing unit 250 executes carrier sensing for confirming the channel state. In the case where the channel is in a busy state, the wireless signal processing unit 250 continues the carrier sensing. In the case where the channel is in an idle state, the wireless signal processing unit 250 generates the wireless frame by adding a preamble or the like to the MAC frame input from the MAC frame processing unit 240. Then, the wireless signal processing unit 250 converts the generated wireless frame into the wireless signal (wireless medium). Then, the wireless signal processing unit 250 radiates (transmits) the converted wireless signal via the antenna. On the other hand, in the case of receiving the wireless signal, the wireless signal processing unit 250 converts the wireless signal received via the antenna into the wireless frame. Then, the wireless signal processing unit 250 extracts the MAC frame from the converted wireless frame, and inputs the extracted MAC frame to the MAC frame processing unit 240.

Note that the wireless signal processing unit 250 may be referred to as an “STA function”. The conversion processing from the wireless frame to the wireless signal by the wireless signal processing unit 250 includes, for example, any of convolutional encoding processing, interleave processing, subcarrier modulation processing, inverse fast Fourier transform processing, orthogonal frequency division multiplexing (OFDM) modulation processing, and frequency conversion processing. The conversion processing from the wireless signal to the wireless frame by the wireless signal processing unit 250 includes, for example, any of frequency conversion processing, OFDM demodulation processing, fast Fourier transform processing, subcarrier demodulation processing, deinterleave processing, and Viterbi decoding processing. The access point AP may include a plurality of the wireless signal processing units 250 that each handles a different channel, or may include a plurality of the wireless signal processing units 250 that handles different frequency bands.

### (Configuration of Channel Access Function of Access Point AP)

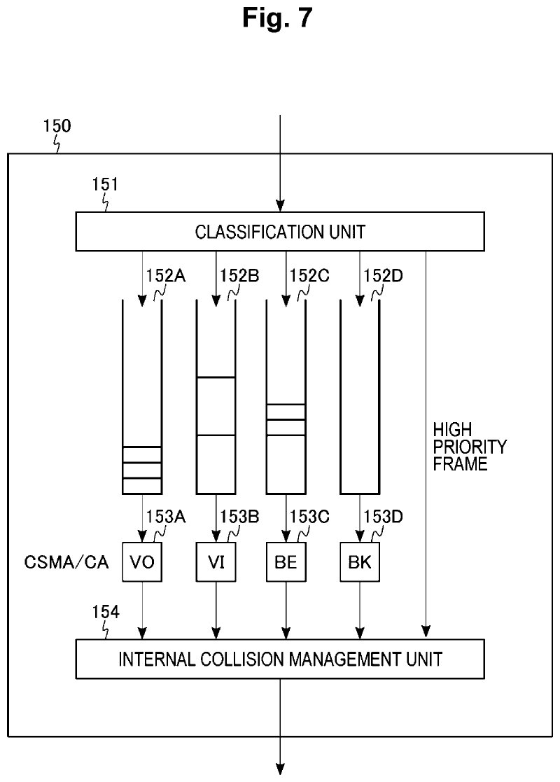

FIG. 7 is a block diagram illustrating an example of a configuration of a channel access function of the access point AP according to the first embodiment. As illustrated in FIG. 7, the wireless signal processing unit 150 of the access point AP includes, for example, a classification unit 151, queues 152A, 152B, 152C, and 152D, carrier sensing execution units 153A, 153B, 153C, and 153D, and an internal collision management unit 154.
in the case where the MAC frame input from the MAC frame processing unit 140 is a data frame, the classification unit 151 classifies the data frame into a plurality of access categories voice (VO), video (VI), best effort (BE), and background (BK) on the basis of the traffic type (TID) included in the MAC header. Then, the classification unit 151 inputs the data frame to the corresponding queues 152 among the plurality of queues 152A, 152B, 152C, and 152D. In the present example, the classification unit 151 inputs the data frames corresponding to the access categories VO, VI, BE, and BK to the queues 152A, 152B, 152C, and 152D, respectively. Furthermore, in the case where the MAC frame input from the MAC frame processing unit 140 is a high priority frame such as a trigger frame, the classification unit 151 inputs the high priority frame to the internal collision management unit 154 without passing through the queue 152, for example. Note that low latency (LL) may be provided as the access category.

Each of the plurality of queues 152A, 152B, 152C, and 152D buffers an input data frame. In the present example, the plurality of queues 152A, 152B, 152C, and 152D buffers the data frames corresponding to the access categories VO, VI, BE, and BK, respectively.

Each of the plurality of carrier sensing execution units 153A, 153B, 153C, and 153D is associated with each of the plurality of queues 152A, 152B, 152C, and 152D. Each of the plurality of carrier sensing execution units 153A, 153B, 153C, and 153D executes carrier sensing based on CSMA/CA according to a preset access parameter. The access parameter is set for each access category, and is set such that transmission of the wireless signal is prioritized in the order of “VO”, “VI”, “BE”, and “BK”, for example. In a case where it is determined that the channel is in the idle state for a predetermined time, each of the plurality of carrier sensing execution units 153A, 153B, 153C, and 153D acquires a transmission right of the data frame and terminates the carrier sensing. In a case where it is determined that the channel is in the busy state, each of the plurality of carrier sensing execution units 153A, 153B, 153C, and 153D stops the acquisition of the transmission right and terminates the carrier sensing. The carrier sensing execution unit 153 that has acquired the transmission right extracts the data frame from the associated queue 152 and outputs the extracted data frame to the internal collision management unit 154.

The internal collision management unit 154 prevents transmission collision in a case where a plurality of the carrier sensing execution units 153 simultaneously acquires the transmission right. Specifically, in a case where a plurality of the data frames is simultaneously input, the internal collision management unit 154 preferentially outputs the data frame of the access category having a high priority. The data frame output from the internal collision management unit 154 is converted into the wireless frame and transmitted via the antenna.

When a high priority frame such as a trigger frame is input, the wireless signal processing unit 150 performs the carrier sensing and then transmits the wireless signal including the high priority frame via the antenna. Since the carrier sensing is executed without passing through the queue 152, the high priority frame can be processed with lower latency than other traffic. In the case of transmitting the high priority frame, the wireless signal processing unit 150 may temporarily stop the carrier sensing of the other queues 152. In addition, the wireless signal processing unit 150 may generate the trigger frame on the basis of the rTWT start time TS notification of which is provided from the management unit 130.

As the access parameter used for the carrier sensing, for example, contention window (CW) min, CWmax, arbitration inter frame space (AIFS), or transmission opportunity (TXOP) limit is used. The contention window is a parameter used to determine a transmission wait time for collision avoidance. The CWmin and the CWmax indicate a minimum value and a maximum value of the contention window, respectively. The arbitration inter frame space (AIFS) indicates a fixed transmission wait time set for each access category for collision avoidance control that has a priority control function. The TXOP corresponds to an occupancy time of a channel. The TXOPLimit indicates an upper limit value of TXOP. The shorter the CWmin and the CWmax are, the easier the queue 152 can obtain the transmission right. The priority of the queue 152 increases as the AIFS decreases. The amount of data transmitted with one transmission right increases as the value of the TXOPLimit increases. The access parameter may be referred to as an enhanced distributed channel access (EDCA) parameter.

Note that, in the communication system 1, the configuration regarding the channel access function of the wireless terminal apparatus WTA is equivalent to the configuration regarding the channel access function of the access point AP. In the present specification, a case where the channel access function of the access point AP is implemented in the wireless signal processing unit 150 has been described, but the channel access function of the access point AP may be implemented in the MAC frame processing unit 140. Similarly, the channel access function of the wireless terminal apparatus WTA may be implemented in the wireless signal processing unit 250 or may be implemented in the MAC frame processing unit 240.

### <1-2> Operation

### <1-2-1> Link Setup Method

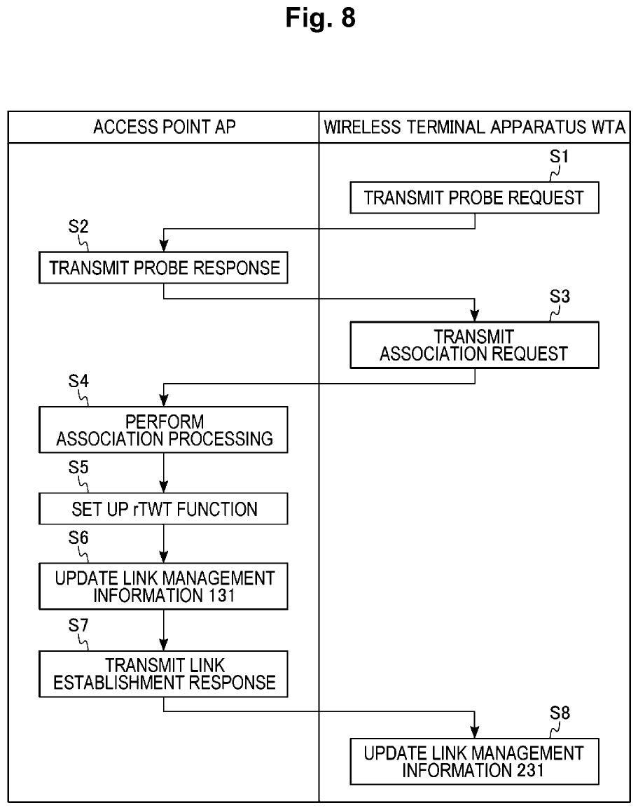

FIG. 8 is a flowchart illustrating an example of a link setup method of the communication system 1 according to the first embodiment. Hereinafter, the link setup method using the rTWT function will be described with reference to FIG. 8. The link setup is executed by, for example, transmitting and receiving the management frame between the management unit 130 of the access point AP and the management unit 230 of the wireless terminal apparatus WTA.

First, the wireless terminal apparatus WTA transmits (broadcasts) a probe request to the access point AP (S1). The probe request is a signal for confirming whether the access point AP exists around the wireless terminal apparatus WTA.

When receiving the probe request, the access point AP transmits a probe response to the wireless terminal apparatus WTA (S2). The probe response is a signal used for a response to the probe request from the wireless terminal apparatus WTA, and includes information necessary for establishing a link.

When receiving the probe response, the wireless terminal apparatus WTA transmits an association request to the access point AP (S3). The association request is a signal for requesting the access point AP to establish a link, and includes information for link connection. In the case where the rTWT function is used, the association request includes, for example, information regarding a generation cycle of low latency traffic.

When receiving the association request, the access point AP performs the association processing (S4). In the association processing, the access point AP establishes a wireless connection (link) with the STA function of the wireless terminal apparatus WTA.

Once the link is established, the access point AP sets up the rTWT function (S5). In the setup of the rTWT function, for example, the management unit 130 sets the rTWT start time TS, the rTWT duration TD, and the rTWT cycle in accordance with the generation cycle of the low latency traffic. The access point AP may acquire, from the wireless terminal apparatus WTA, information of a data generation cycle set for the application that generates low latency traffic, and the like, and use the information for setting up the rTWT function. Any means may be used as a method by which the access point AP acquires the generation cycle of the low latency traffic and the like.

When the setup of the rTWT function is completed, the access point AP updates the link management information 131 on the basis of the configuration of the established link and the configuration of the rTWT function (S6).

When the update of the link management information 131 is completed, the access point AP transmits a link establishment response to the wireless terminal apparatus WTA (S7). The link establishment response is a signal used for a response to the association request from the wireless terminal apparatus WTA.

When receiving the link establishment response from the access point AP, the wireless terminal apparatus WTA updates the link management information 231 on the basis of the configuration of the link and the configuration of the rTWT function included in the received link establishment response (S8). As a result, the link management information is updated in both the access point AP and the wireless terminal apparatus WTA, and the link setup is completed. Thereafter, the access point AP and the wireless terminal apparatus WTA can execute data communication using the rTWT function.

Note that the configuration of the rTWT function may be changed after the link is established. The change of the configuration of the rTWT function after the link is established may be executed mainly by the access point AP, or may be executed mainly by the wireless terminal apparatus WTA. The access point AP can notify the wireless terminal apparatus WTA of the configuration of the rTWT function by using a beacon. The link setup may also be executed on the basis of a beacon periodically transmitted by the access point AP. In this case, the wireless terminal apparatus WTA executes the processing of S3 on the basis of reception of the beacon. That is, the processing of S1 and S2 can be omitted. Further, the channel used by the wireless terminal apparatus WTA may be determined by the access point AP or may be determined by the wireless terminal apparatus WTA. In the case where the access point AP determines the channel, the access point AP may notify the wireless terminal apparatus WTA of the channel to be used by the trigger frame TF or may notify the wireless terminal apparatus WTA of the channel by a beacon.

### (Format of Beacon Frame)

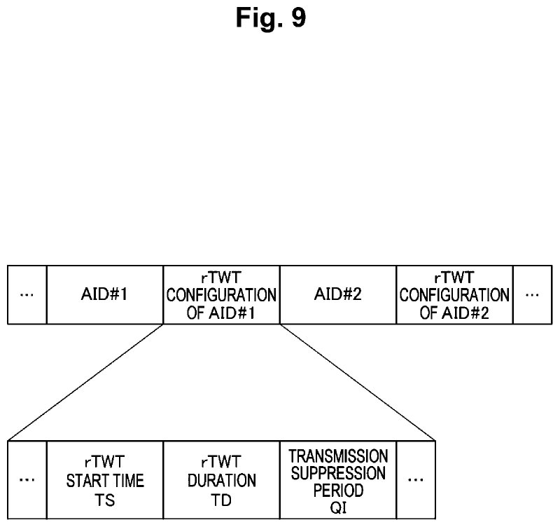

FIG. 9 is a schematic diagram illustrating an example of a format of the beacon frame transmitted by the access point AP included in the communication system 1 according to the first embodiment. As illustrated in FIG. 9, the beacon frame includes, for example, a plurality of sets of combinations of information of an association identifier (AID) and the rTWT configuration (for example, the rTWT start time TS, the rTWT duration TD, and the transmission suppression period QI) associated with the AID.

The AID is an identifier of the wireless terminal apparatus WTA that has established the link. The beacon frame illustrated in FIG. 9 includes the rTWT configuration of AID #1 and the rTWT configuration of AID #2. The wireless terminal apparatus WTA refers to the AID included in the beacon frame and can determine whether the management information is for its own station. The beacon frame may include, instead of the AID, an identifier of a group that shares the configuration of the rTWT function. In this case, the access point AP transmits a beacon including information obtained by combining the identifier of the group of wireless terminal apparatuses WTA that shares the configuration of the rTWT function and the rTWT configuration associated with the group.

When receiving the beacon, the beacon processing unit 233 of each wireless terminal apparatus WTA acquires the rTWT start time TS, the rTWT duration TD, and the transmission suppression period QI, and notifies the wireless signal processing unit 250 of the acquired information. As a result, the access point AP can cause the wireless terminal apparatus WTA supporting the rTWT function among the plurality of wireless terminal apparatuses WTA connected wirelessly to execute an operation based on the rTWT configuration, and cause the wireless terminal apparatus WTA not supporting the rTWT function to spontaneously suppress the transmission of uplink data in the rTWT service period SP. Meanwhile, the wireless terminal apparatus WTA that supports the rTWT function and for which communication is not allocated within the set rTWT service period SP (that is, the wireless terminal apparatus WTA outside the member of the rTWT service period SP) can suppress spontaneous transmission within the set rTWT service period SP by receiving the beacon.

Note that the information indicating the transmission suppression period QI included in the beacon frame may be omitted in a case where, for example, the rTWT duration TD and the transmission suppression period QI have the same length. In this case, the wireless terminal apparatus WTA sets a period based on the rTWT start time TS and the rTWT duration TD as the transmission suppression period QI.

### <1-2-2> Frame Exchange Method

Hereinafter, an example of a frame exchange method of the communication system 1 according to the first embodiment will be described. In the present example, a case where the access point AP establishes links with three wireless terminal apparatuses WTA by using the same channel and receives low latency traffic by using the rTWT function will be described. In the communication system 1 according to the first embodiment, the access point AP manages the priority of the low latency traffic for each link that uses the rTWT function.

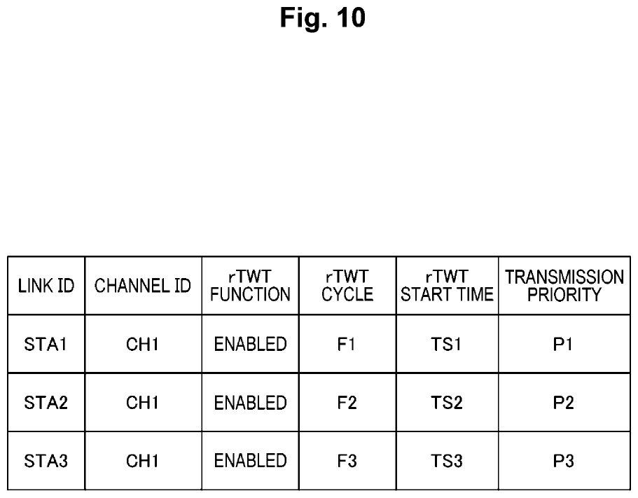

FIG. 10 is a table illustrating an example of the link management information 131 of the access point AP according to the first embodiment. As illustrated in FIG. 10, the link management information 131 includes, for example, information regarding “link ID”, “channel ID”, “rTWT function”, “rTWT cycle”, “rTWT start time”, and “transmission priority”.

The item of “link ID” indicates the identifier of the link associated with the STA function of each of the access point AP and the wireless terminal apparatus WTA. In the present example, STA1, STA2, and STA3 are allocated as the link IDs corresponding to the three wireless terminal apparatuses WTA. The item of “channel ID” indicates the identifier of the channel used for each link. In the present example, a common channel CH1 is allocated to each of STA1, STA2, and STA3. The item of “rTWT function” indicates whether the rTWT function is enabled. In the present example, the rTWT function of each of STA1, STA2, and STA3 is enabled (FIG. 2: enabled).

The item “rTWT cycle” indicates the configuration of the rTWT cycle. In the present example, rTWT cycles F1, F2, and F3 are set in STA1, STA2, and STA3, respectively. F1 is a cycle shorter than F2 and longer than F3. The item of “rTWT start time” indicates the configuration of the rTWT start time TS. In the present example, rTWT start times TS1, TS2, and TS3 are set for STA1, STA2, and STA3, respectively, and TS1, TS2, and TS3 are set to the same time.

The item of “transmission priority” indicates the transmission priority of the low latency traffic to be transmitted in the rTWT service period SP. In the present example, transmission priorities P1, P2, and P3 are set for STA1, STA2, and STA3, respectively. The transmission priority P1 is higher than the transmission priority P2. The transmission priority P2 is higher than the transmission priority P3. The low latency traffic is required to be processed with lower latency as the transmission priority is higher. The transmission priority is calculated by the rTWT configuration management unit 134 on the basis of information such as a requested delay time, for example.

(Method of Setting rTWT Service Period SP)

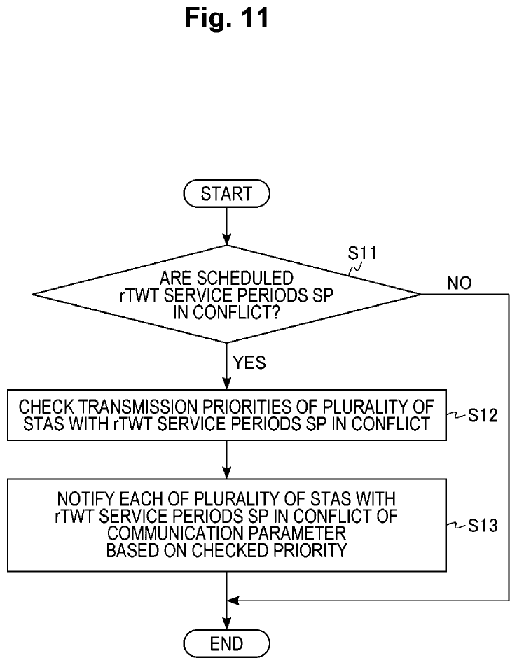

FIG. 11 is a flowchart illustrating an example of a method of setting the rTWT service period SP in the communication system 1 according to the first embodiment. Hereinafter, a flow of setting the rTWT service period SP in the communication system 1 according to the first embodiment will be described with reference to FIG. 11.

For example, when establishing links using the rTWT function to a plurality of wireless terminal apparatuses WTA (start), the access point AP checks whether the scheduled rTWT service periods SP are in conflict (S11). For example, in a case where the rTWT start times TS of the plurality of links coincides with each other, the access point AP determines that the plurality of rTWT service periods SP conflict with each other. The access point AP may determine that the rTWT service periods conflict on the basis of overlapping of the rTWT service periods SP of the plurality of links. In addition, the access point AP may determine that the rTWT service periods SP do not conflict when it is estimated that some of the rTWT service periods SP of the plurality of links overlap but the transmission periods of the low latency traffic do not overlap.

In the processing of S11, in the case where it is determined that the scheduled rTWT service periods SP do not conflict (S11: NO), the access point AP terminates the series of processing illustrated in FIG. 11 (end).

In the processing of S11, when it is determined that the scheduled rTWT service periods SP conflict with each other (S11: YES), the access point AP checks the transmission priorities of the plurality of STAs (wireless terminal apparatuses WTA) in which the rTWT service periods SP conflict with each other (S12). When the processing of S12 is completed, the access point AP proceeds to the processing of S13.

In the processing of S13, the access point AP notifies a communication parameter based on the confirmed transmission priority to each of the plurality of STAs in which the rTWT service periods SP conflict with each other (S13). The communication parameter provided as notification is, for example, a parameter for determining the transmission standby period from the start of the rTWT service period SP to the start of frame transmission. The access point AP may use a beacon frame or a management frame to notify the communication parameter. The wireless terminal apparatus WTA updates the link management information 231 on the basis of the communication parameter provided as notification. Specifically, the wireless terminal apparatus WTA extracts the EDCA parameter and the like from the communication parameter notification of which is provided from the access point AP, for example, and updates the communication parameter to be applied to the rTWT service period SP. When the processing of S13 is completed, the access point AP terminates the series of processing illustrated in FIG. 11 (end).

Note that the access point AP may start the series of processing illustrated in FIG. 11 on the basis of a preset schedule, or may execute the series of processing at the timing when the rTWT configuration of any of the plurality of wireless terminal apparatuses WTA that has established a link is updated. The timing at which the access point AP notifies the communication parameter in the processing of S13 may be the rTWT start time TS. In the processing of S13, the notification of the communication parameter to the wireless terminal apparatus WTA having the highest transmission priority may be omitted. The communication parameter that the access point AP instructs the wireless terminal apparatus WTA to change in the processing of S13 may be the EDCA parameter such as contention window, or may be a fixed value such as an AIFS.

### (Specific Example of Frame Exchange Method)

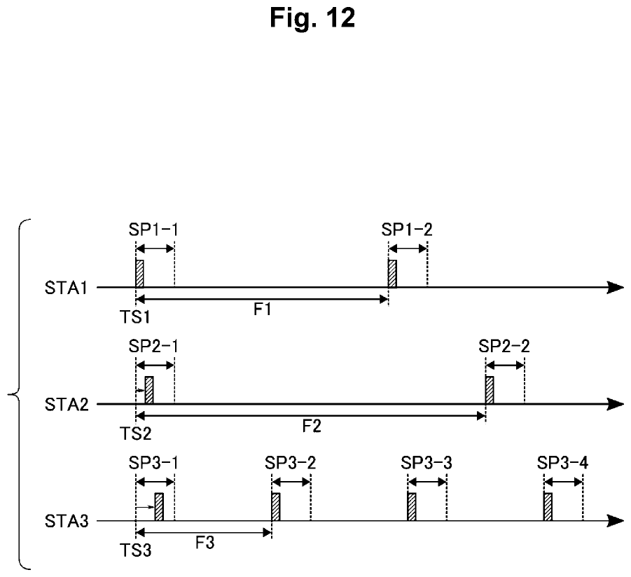

FIG. 12 is a time chart illustrating a specific example of a frame exchange method using the rTWT function of the communication system 1 according to the first embodiment. FIG. 12 illustrates a frame exchange operation executed between the access point AP and the three wireless terminal apparatuses WTA (STA1, STA2, and STA3) by using the rTWT function. SP1-1 and SP1-2 correspond to the rTWT service period SP1 allocated to STA1. The start timing of SP1 is based on the rTWT cycle F1 of STA1. SP2-1 and SP2-2 correspond to the rTWT service period SP2 allocated to STA2. The start timing of SP2 is based on the rTWT cycle F2 of STA2. SP3-1, SP3-2, SP3-3, and SP3-4 correspond to the rTWT service period SP3 allocated to STA3. The start timing of SP3 is based on the rTWT cycle F3 of STA3.

As illustrated in FIG. 12, in the present example, the rTWT start times TS1, TS2, and TS3 of STA1, STA2, and STA3 coincide with one another. Therefore, the rTWT service periods SP1-1, SP2-1, and SP3-1 conflict (overlap) with one another. Then, the transmission priorities P1, P2, and P3 are set for STA1, STA2, and STA3, respectively. Therefore, the access point AP preferentially executes the frame exchange in the order of STA1, STA2, and STA3. Specifically, for example, the access point AP sets STA2 to an AIFS longer than STA1, and sets STA3 to an AIFS longer than STA2. Then, the access point AP notifies the corresponding STA function of these communication parameters. Other access parameters may be used as the communication parameter set on the basis of the transmission priority.

As a result, in the conflicting rTWT service periods SP1-1, SP2-1, and SP3-1, a frame exchange opportunity (transmission opportunity) is given to STA1, STA2, and STA3 in this order. That is, the timing at which the low latency traffic of STAL is transmitted in the rTWT service period SP1-1 is earlier than the timing at which the low latency traffic of STA2 is transmitted in the rTWT service period SP2-1. Further, the timing at which the low latency traffic of STA2 is transmitted in the rTWT service period SP2-1 is earlier than the timing at which the low latency traffic of STA3 is transmitted in the rTWT service period SP3-1. In a case where the rTWT service periods SP do not conflict with one another, the processing regarding the transmission of the low latency traffic can be started at the rTWT start time TS of each rTWT service period SP.

### <1-3> Advantageous Effects of First Embodiment

According to the communication system 1 of the first embodiment, the access point AP can control the plurality of wireless terminal apparatuses WTA so as to satisfy the delay requirement condition of the low latency traffic of each of the plurality of wireless terminal apparatuses WTA. Hereinafter, effects of the first embodiment will be described in detail.

In the wireless communication system, the rTWT function is considered as a function to preferentially secure the transmission opportunity of low latency traffic. The access point AP using the rTWT function sets the rTWT cycle so as to synchronize with the periodically generated low latency traffic. For example, the access point AP sets up the rTWT function for each traffic type periodically generated, and sets the rTWT cycle for each traffic type.

However, there is a possibility that some pieces of low latency traffic are generated at the same timing depending on the generation cycle of each of the plurality of pieces of low latency traffic. That is, there is a case where transmission of the low latency traffic conflicts among a plurality of wireless terminal apparatuses WTA (STA functions). In this case, a channel access conflict for obtaining the frame transmission right occurs in the conflicting rTWT service periods SP. Then, the access point AP may not be able to guarantee preferential transmission of traffic with strict delay requirement conditions.

Therefore, in the communication system 1 according to the first embodiment, the transmission priority is determined for each low latency traffic. Then, the low latency traffic transmitted within the same transmission period due to the conflict of the rTWT service periods SP is preferentially transmitted from the one with a stricter delay requirement condition on the basis of the transmission priority. Specifically, the access point AP notifies the corresponding STA function of the communication parameter in the rTWT service period SP determined on the basis of the transmission priority. Then, each of the STA functions attempts channel access using the communication parameter provided as notification in the conflicting rTWT service period SP.

As a result, the communication system 1 according to the first embodiment can preferentially transmit traffic having a strict delay requirement condition and can satisfy the delay requirement condition of the traffic even in a case where a plurality of pieces of low latency traffic conflicts with one another. Therefore, the access point AP of the communication system 1 according to the first embodiment can control the plurality of wireless terminal apparatuses WTA so as to satisfy the delay requirement condition of the low latency traffic of each of the plurality of wireless terminal apparatuses WTA.

### <2> Second Embodiment

A communication system 1a according to a second embodiment has a configuration similar to the communication system 1 according to the first embodiment. Then, the communication system la according to the second embodiment changes an rTWT configuration of a wireless terminal apparatus WTA in which an rTWT service period SP conflicts on the basis of a transmission priority. Hereinafter, details of the communication system la according to the second embodiment will be described.

### <2-1> Frame Exchange Method

Hereinafter, an example of a frame exchange method of the communication system la according to the second embodiment will be described. In the present example, a case where the access point AP establishes links with three wireless terminal apparatuses WTA by using the same channel and receives low latency traffic by using the rTWT function will be described.

(Method of Setting rTWT Service Period SP)

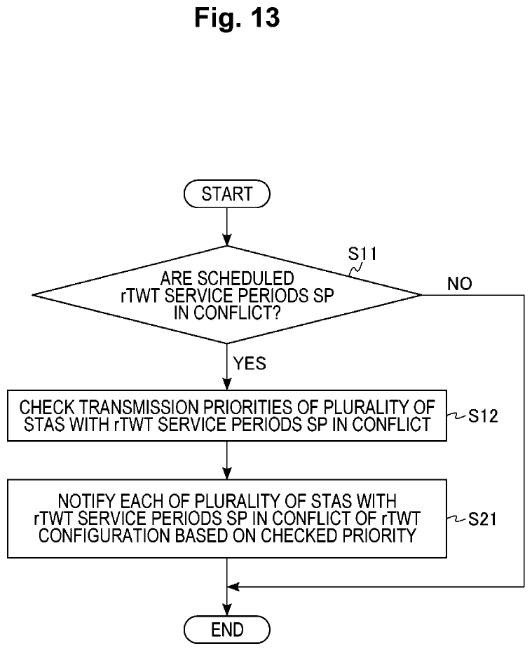

FIG. 13 is a flowchart illustrating an example of a method of setting the rTWT service period SP in the communication system la according to the second embodiment. Hereinafter, a flow of setting the rTWT service period SP in the communication system la according to the second embodiment will be described with reference to FIG. 13.

For example, when establishing links using the rTWT function to the plurality of wireless terminal apparatuses WTA (start), the access point AP according to the second embodiment checks whether scheduled rTWT service periods SP are in conflict (S11), similarly to the first embodiment.

In the processing of S11, in the case where it is determined that the scheduled rTWT service periods SP do not conflict (S11: NO), the access point AP terminates the series of processing illustrated in FIG. 11 (end).

In the processing of S11, when it is determined that the scheduled rTWT service periods SP conflict with each other (S11: YES), the access point AP checks the transmission priorities of the plurality of STAs (wireless terminal apparatuses WTA) in which the rTWT service periods SP conflict with each other (S12), similarly to the first embodiment. When the processing of S12 is completed, the access point AP proceeds to the processing of S21.

In the processing of S21, the access point AP notifies the rTWT configuration based on the confirmed transmission priority to each of the plurality of STAs in which the rTWT service periods SP conflict with each other (S21). The access point AP may use a beacon frame or a management frame to notify the rTWT configuration. The wireless terminal apparatus WTA updates link management information 231 on the basis of the rTWT configuration provided as notification. Specifically, the wireless terminal apparatus WTA extracts a TWT configuration such as rTWT start time TS from the communication parameter notification of which is provided from the access point AP and reflects the extracted configuration in the link management information 231. When the processing of S21 is completed, the access point AP terminates the series of processing illustrated in FIG. 13 (end).

Note that the access point AP according to the second embodiment may start the series of processing illustrated in FIG. 13 on the basis of a preset schedule, or may execute the series of processing at timing when the rTWT configuration of any of the plurality of wireless terminal apparatuses WTA that has established a link is updated. The access point AP according to the second embodiment may omit notification of the rTWT configuration to the wireless terminal apparatus WTA having the highest transmission priority in the processing of S13.

### (Specific Example of Frame Exchange Method)

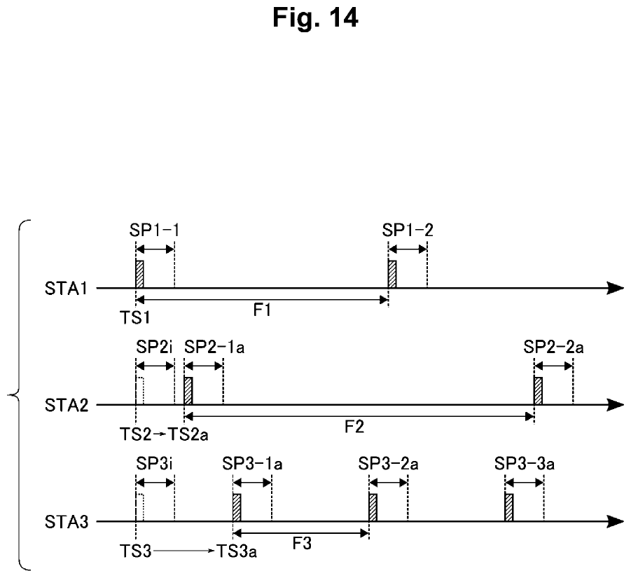

FIG. 14 is a time chart illustrating a specific example of the frame exchange method using the rTWT function of the communication system la according to the second embodiment. FIG. 14 illustrates a frame exchange operation executed between the access point AP and the three wireless terminal apparatuses WTA (STA1, STA2, and STA3) by using the rTWT function. SP1-1 and SP1-2 correspond to the rTWT service period SP1 allocated to STA1. SP2-1a and SP2-2a correspond to an rTWT service period SP2 allocated to STA2. SP3-1a, SP3-2a, and SP3-3a correspond to an rTWT service period SP3 allocated to STA3. Note that SP2i indicates the rTWT service period SP2 of STA2 in a case where the rTWT configuration is not changed from an initial configuration. SP3i indicates the rTWT service period SP3 of STA3 in a case where the rTWT configuration is not changed from an initial configuration.

As illustrated in FIG. 14, in the present example, in the initial configuration, the rTWT start times TS1, TS2, and TS3 of STA1, STA2, and STA3 coincide with one another. Therefore, in the initial configuration, the rTWT service periods SP1-1, SP2-1, and SP3-1 conflict (overlap) with one another. In this case, the access point AP according to the second embodiment changes the rTWT configuration on the basis of the transmission priority of each of STA1, STA2, and STA3.

Specifically, for example, the access point AP changes the TWT start time of STA2 from TS2 to TS2a later than TS2, and changes the rTWT start time of STA3 from TS3 to TS3a later than TS3. Meanwhile, the access point AP maintains the rTWT start time TS1 of STAI having the highest transmission priority as it is. In other words, the access point AP according to the second embodiment does not change the start time of the rTWT service period SP1 having the highest transmission priority from the scheduled time. Then, as the transmission priority decreases, the access point AP delays the start time of the rTWT service period SP of each of the rTWT service periods SP2 and SP3.

As a result, in the rTWT service periods SP1-1, SP2-1a, and SP3-1a, conflict of the rTWT service periods SP among the STA functions (wireless terminal apparatuses WTA) is resolved. Then, the timing at which the low latency traffic of STAL is transmitted in the rTWT service period SP1-1 is earlier than the timing at which the low latency traffic of STA2 is transmitted in the rTWT service period SP2-1a. The timing at which the low latency traffic of STA2 is transmitted in the rTWT service period SP2-1a is earlier than the timing at which the low latency traffic of STA3 is transmitted in the rTWT service period SP3-1a.

Note that, in the communication system la, the wireless terminal apparatuses WTA may have partially overlapping rTWT service periods SP after changing the rTWT configuration as long as the frame exchange regarding the low latency traffic can be executed at the rTWT start time.

### <2-2> Advantageous Effects of Second Embodiment

As described above, in the case of determining that the plurality of rTWT service periods SP conflict with each other at the same time, the communication system 1a according to the second embodiment changes the start time (rTWT start time TS) of the rTWT service period SP on the basis of the transmission priority.

As a result, the communication system la according to the second embodiment can preferentially transmit traffic having a strict delay requirement condition and can satisfy a delay requirement condition of the traffic even in a case where a plurality of pieces of low latency traffic conflicts with one another. Therefore, the access point AP of the communication system la according to the second embodiment can control the plurality of wireless terminal apparatuses WTA so as to satisfy the delay requirement condition of the low latency traffic of each of the plurality of wireless terminal apparatuses WTA, similarly to the first embodiment.

### <3> Third Embodiment

A communication system 2 according to a third embodiment executes a part of the processing of the access point AP described in the first embodiment or the second embodiment by an external control device. Hereinafter, a communication system 2 according to the third embodiment will be described.

### <3-1> Configuration

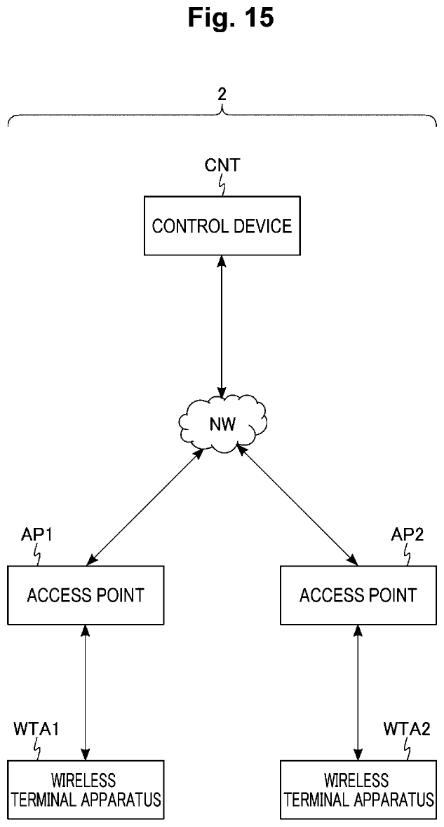

FIG. 15 is a block diagram illustrating an example of a configuration of the communication system 2 according to the third embodiment. As illustrated in FIG. 15, the communication system 2 includes, for example, access points AP1 and AP2, wireless terminal apparatuses WTA1 and WTA2, and a control device CNT.

A configuration of each of the access points AP1 and AP2 is similar to the configuration of the access point AP described in the first embodiment, for example. A configuration of each of the wireless terminal apparatuses WTA1 and WTA2 is similar to the configuration of the wireless terminal apparatus WTA described in the first embodiment, for example. The number of wireless terminal apparatuses WTA connected to the respective access points AP may be two or more.

The control device CNT is a device that controls a plurality of access points AP. The control device CNT is configured to be able to communicate with each of the access points AP1 and AP2 via a network NW. A hardware configuration of the control device CNT has, for example, a configuration in which the wireless communication module 14 is omitted from the configuration of the access point AP illustrated in FIG. 3. Note that the number of access points AP connected to the control device CNT may be one or three or more. Unlike the above description, the control device CNT may be configured to be connectable to the network NW or the access point AP via a wireless communication module 14. The control device CNT may have a function as an access point AP, and may be referred to as an “access point”.

In addition, the control device CNT has a function similar to the rTWT configuration management unit 134 described in the first embodiment. The control device CNT can manage an rTWT configuration of each access point AP belonging to the control device CNT. The rTWT configuration of each access point AP may be spontaneously provided as notification from the access point AP that has set up a link with the wireless terminal apparatus WTA to the control device CNT, or may be provided as notification from the access point AP to the control device CNT in response to a request from the control device CNT.

### <3-2> Operation

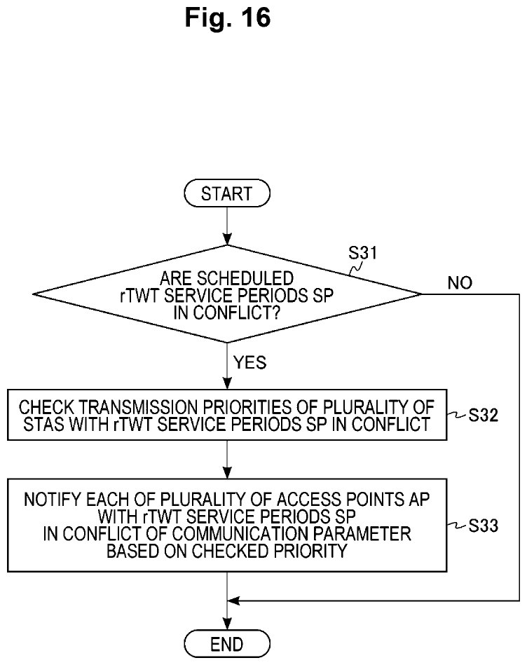

FIG. 16 is a flowchart illustrating an example of a communication control method in the communication system 2 according to the third embodiment. Hereinafter, a flow of a communication control method in the communication system 2 according to the third embodiment will be described with reference to FIG. 16.

For example, when the control device CNT is notified of the rTWT configuration from a plurality of access points AP (start), the control device CNT checks whether rTWT service periods SP scheduled on a same channel CH in each access point AP conflict with each other (S31). For example, when rTWT start times TS allocated to the same channel CH match between the plurality of access points AP, the control device CNT determines that the plurality of rTWT service periods SP conflict with each other. The control device CNT may determine that the rTWT service periods conflict on the basis of a fact that the rTWT service periods SP allocated to the same channel CH overlap between the plurality of access points AP. In addition, the control device CNT may determine that the rTWT service periods SP do not conflict with each other when it is estimated that transmission periods of low latency traffic do not overlap although a part of the rTWT service periods SP allocated to the same channel CH overlaps between the plurality of access points AP.

In processing of S31, when it is determined that the scheduled rTWT service periods SP do not conflict (S31: NO), the control device CNT terminates a series of processing illustrated in FIG. 16 (end).

In the processing of S31, when it is determined that the scheduled rTWT service periods SP conflict with each other (S31: YES), the control device CNT checks transmission priorities of the plurality of STAs (that is, the STAs using the rTWT function in each access point AP) in which the rTWT service periods SP conflict with each other (S32). When the processing of S32 is completed, the control device CNT proceeds to the processing of S33.

In the processing of S33, the control device CNT notifies each of the plurality of access points AP having a conflicting rTWT service period SP of a communication parameter based on the confirmed transmission priority (S33). The communication parameter provided as notification is, for example, a parameter for determining the transmission standby period from the start of the rTWT service period SP to the start of frame transmission. The access point AP updates link management information 131 on the basis of the communication parameter provided as notification. Then, the access point AP notifies the corresponding wireless terminal apparatus WTA of the communication parameter notification of which is provided from the control device CNT. When the processing of S33 is completed, the control device CNT terminates the series of processing illustrated in FIG. 16 (end).

Note that the control device CNT may start the series of processing illustrated in FIG. 16 on the basis of a preset schedule, or may execute the series of processing at timing when any rTWT configuration of the plurality of access points AP that uses the rTWT function is updated. In the processing of S33, the notification of the communication parameter to the access point AP having the highest transmission priority may be omitted. The communication parameter that the control device CNT instructs the access point AP to change in the processing of S33 may be an EDCA parameter such as a contention window, or may be a fixed value such as AIFS.

### <3-3> Advantageous Effects of Third Embodiment

As described above, in the communication system 2 according to the third embodiment, the control device CNT determines whether the rTWT service periods SP of the plurality of access points AP conflicts with each other. Then, when determining that the rTWT service periods SP conflict with each other, the control device CNT changes the communication parameter in at least one access point AP on the basis of the transmission priority.

As a result, the communication system 2 according to the third embodiment can suppress a transmission delay of low latency traffic due to the conflict of the channel CH that uses the rTWT function between the plurality of access points AP. Therefore, the control device CNT of the communication system 2 according to the third embodiment can control the plurality of access points AP so as to satisfy a delay requirement condition of the low latency traffic of each of the plurality of wireless terminal apparatuses WTA.

In the third embodiment, the control device CNT notifies the access point AP of the change in the communication parameter, but the present invention is not limited thereto. The control device CNT may notify the access point AP of the change in the rTWT configuration instead of the communication parameter. Even in such a case, the control device CNT in the third embodiment can suppress the transmission delay of the low latency traffic.

### <4> Others

In the above embodiments, the access point AP may establish a multi-link with the wireless terminal apparatus WTA by using a plurality of channels. Each of the access point AP and the wireless terminal apparatus WTA can include a plurality of the wireless signal processing units (STA functions) corresponding to the plurality of channels, respectively. In the case where the multi-link is established, a multi-link association request and multi-link association processing are executed using any of the plurality of STA functions instead of the processing of S3 and S4 illustrated in FIG. 9. Note that, when the multi-link is established, the authentication and the association processing of other links constituting the multi-link may be executed using one link for which a link with the access point AP is first established. In the case of using the multi-link, the communication system 1 can dynamically determine which link the frame exchange is performed in each rTWT service period SP. In the multi-link, one or a plurality of STA functions can be allocated to one traffic type. For example, the association between the traffic and the STA function is set such that a traffic amount (data amount) becomes equal among the plurality of links forming the multi-link. The present invention is not limited thereto, and traffic of similar types (priority/non-priority or the like) may be collected in a specific link constituting the multi-link.

In the communication system 1, each of the CPU 11 included in the access point AP and the CPU 21 included in the wireless terminal apparatus WTA may be another circuit. For example, each of the access point AP and the wireless terminal apparatus WTA may include a micro processing unit (MPU) or the like instead of the CPU. Each of the processing described in the embodiment may be implemented by dedicated hardware. Each processing of the access point AP and the wireless terminal apparatus WTA may include processing executed by software and processing executed by hardware in combination or may include only one of the pieces of processing. The set of the data processing unit 120, the management unit 130, and the MAC frame processing unit 140 included in the access point AP may be referred to as a “link management unit”. Similarly, the set of the data processing unit 220, the management unit 230, and the MAC frame processing unit 240 included in the wireless terminal apparatus WTA may be referred to as a “link management unit”.

In the embodiments, the flowcharts used to describe the operations are merely examples. Each operation described in the embodiments may be interchanged within a possible processing order, or other processing may be added. For example, the link setup method described in the first embodiment is merely one example. Furthermore, the format of the wireless frame described in the first embodiment is merely one example. In the communication system 1, other formats may be used as long as the operations described in the embodiments can be executed. A wireless communication standard different from the IEEE 802.11 standard may be used as the wireless communication between the access point AP and the wireless terminal apparatus WTA.

Note that the present invention is not limited to the above embodiments, and various modifications can be made in the implementation stage without departing from the gist of the invention. In addition, the embodiments may be appropriately combined and implemented, and in this case, combined effects can be obtained. Furthermore, the above embodiments include various inventions, and various inventions can be extracted by combinations selected from a plurality of disclosed components. For example, in a case where the problems can be solved and the advantageous effects can be obtained even if some components are deleted from all the components described in the embodiments, a configuration from which the components are deleted can be extracted as an invention.

### REFERENCE SIGNS LIST

1, 2 Communication system
AP Access point
11 CPU
12 ROM
13 RAM
14 Wireless communication module
15 Wired communication module
110 LLC processing unit
120 Data processing unit
130 Management unit
131 Link management information
132 Link control unit
133 Beacon management unit
134 rTWT configuration management unit
140 MAC frame processing unit
150 Wireless signal processing unit
151 Classification unit
152 Queue
153 Carrier sensing execution unit
154 Internal collision management unit
WTA Wireless terminal apparatus
21 CPU
22 ROM
23 RAM
24 Wireless communication module
25 Display
26 Storage
200 Application execution unit
210 LLC processing unit
220 Data processing unit
230 Management unit
231 Link management information
232 Link control unit
233 Beacon processing unit
240 MAC frame processing unit
250 Wireless signal processing unit
CNT Control device

1. An access point comprising:
a management unit configured to manage a first service period in which a first traffic transmission opportunity is provided to a first wireless terminal apparatus in a first cycle and a second service period in which a second traffic transmission opportunity is provided to a second wireless terminal apparatus in a second cycle, wherein
the management unit is configured to
manage a first transmission priority based on a delay requirement condition of the first traffic and a second transmission priority based on a delay requirement condition of the second traffic, and
notify the second wireless terminal apparatus of a change in a configuration related to the second service period in a case of detecting a conflict between the first service period and the second service period and confirming that the first transmission priority is higher than the second transmission priority.

2. The access point according to claim 1, wherein
the configuration includes a parameter for determining a transmission standby period from start of the second service period to start of frame transmission, and
the management unit is configured to notify the second wireless terminal apparatus of a configuration such that the transmission standby period applied to the second wireless terminal apparatus in the second service period is longer than the transmission standby period applied to the first wireless terminal apparatus in the first service period in a case where the first service period and the second service period conflict with each other.

3. The access point according to claim 1, wherein
the configuration includes a parameter for determining start time of the second service period, and
management unit configured to notify the second wireless terminal apparatus of a configuration such that the start time of the second service period is later than the start time of the first service period in a case where the first service period and the second service period conflict with each other.

4. The access point according to claim 1, wherein
the management unit is configured to determine each of the first transmission priority and the second transmission priority based on a priority of traffic and a traffic type.

5. The access point according to claim 1, wherein
the management unit is configured to determine each of the first transmission priority and the second transmission priority based on the delay requirement condition or jitter of traffic notification of which is provided from an upper layer.

6. A data reception method comprising:
managing a first service period in which a first traffic transmission opportunity is provided to a first wireless terminal apparatus in a first cycle and a second service period in which a second traffic transmission opportunity is provided to a second wireless terminal apparatus in a second cycle;
managing a first transmission priority based on a delay requirement condition of the first traffic and a second transmission priority based on a delay requirement condition of the second traffic; and
notifying the second wireless terminal apparatus of a change in a configuration related to the second service period in a case of detecting a conflict between the first service period and the second service period and confirming that the first transmission priority is higher than the second transmission priority.

7. A non-transitory computer readable medium storing a computer program which is executed by a computer to provide the steps of:
managing a first service period in which a first traffic transmission opportunity is provided to a first wireless terminal apparatus in a first cycle and a second service period in which a second traffic transmission opportunity is provided to a second wireless terminal apparatus in a second cycle;
managing a first transmission priority based on a delay requirement condition of the first traffic and a second transmission priority based on a delay requirement condition of the second traffic; and
notifying the second wireless terminal apparatus of a change in a configuration related to the second service period in a case of detecting a conflict between the first service period and the second service period and confirming that the first transmission priority is higher than the second transmission priority.
